(19) United States
(12) Patent Application Publication
(10) Pub. No.: US 2024/0104299 A1
(43) Pub. Date: Mar. 28, 2024

(54) SYSTEMS AND METHODS FOR COLLABORATIVE AGREEMENT SIGNING

(71) Applicant: ADOBE INC., SAN JOSE, CA (US)

(72) Inventors: Norman A. Stratton, Littleton, MA (US); Jacob Munsey, Monrovia, CA (US); Thu Hien Nguyen, San Francisco, CA (US); Polai Av Eppert, Olympia, WA (US)

(21) Appl. No.: 18/168,677

(22) Filed: Feb. 14, 2023

Related U.S. Application Data
(60) Provisional application No. 63/376,613, filed on Sep. 22, 2022.

(51) Int. Cl. G06F 40/186; G06F 3/0482; G06F 3/0484; G06F 21/31; G06F 40/174

(52) U.S. Cl. CPC G06F 40/186; G06F 3/0482; G06F 3/0484; G06F 21/31; G06F 40/174

(57) ABSTRACT

Systems and methods for collaborative document signing are described. According to one aspects, a method for collaborative document signing includes initiating a live communication session including a user, identifying a source document for an agreement using an agreement signing interface of the live communication session, assigning the user as a signer of the agreement using the agreement signing interface, and generating the agreement. In some cases, the agreement includes the source document. The method further includes obtaining a signature for the agreement from the user and generating a signed agreement including the signature.

### CROSS-REFERENCE TO RELATED APPLICATION

This application claims priority under 35 U.S.C. § 119 to U.S. Provisional Application No. 63/376,613, filed on Sep. 22, 2022, in the United States Patent and Trademark Office, the disclosure of which is incorporated by reference herein in its entirety.

### BACKGROUND

The following relates generally to document generation, and more specifically to the generation of a signed document. Documents may be generated using document generation software. For example, document generation software can be used to create a form document that includes digital content (such as paragraphs of text). In some cases, the content of the document is provided by a user, and in other cases, the content is derived from a database and corresponds to the type of document that is generated.

In some cases, the document generation software can collect a signature (such as an electronic signature) from a user that indicates that the user has signed the contents of the form document. In some cases, the document generation software creates a signed document including the contents of the form document and the signature of the user. The signed document can be shared with the signing user and with other users using digital communication channels, such as email, a website, a file sharing service, etc.

### SUMMARY

Aspects of the present disclosure provide collaborative agreement signing via an agreement signing interface displayed in a user interface of a live communication session. In some cases, the document generation interface allows a user to identify another user as a signer of an agreement and to identify a source document for the agreement. Based on the identification of the user and the source document, aspects of the present disclosure initiate a signing session during which the agreement is generated based on information collected via the agreement signing interface, and a signed agreement including a signature of the other user is generated. Accordingly, by leveraging the agreement signing interface to gather information about the agreement to be signed and a signer of the agreement, aspects of the present disclosure streamline the creation of a signed agreement within a single live communication session.

A method, apparatus, non-transitory computer readable medium, and system for undefined are described. One or more aspects of the method, apparatus, non-transitory computer readable medium, and system include initiating a live communication session including a user; identifying a source document for an agreement using an agreement signing interface of the live communication session; assigning the user as a signer of the agreement using the agreement signing interface; generating the agreement, wherein the agreement includes the source document; obtaining a signature for the agreement from the user; and generating a signed agreement including the signature.

### BRIEF DESCRIPTION OF THE DRAWINGS

FIG. 1 shows an example of an agreement signing system according to aspects of the present disclosure.

FIG. 2 shows an example of a method for signing an agreement in a live communication session according to aspects of the present disclosure.

FIG. 3 shows an example of an agreement signing apparatus according to aspects of the present disclosure.

FIG. 4 shows an example of a method for generating a signed agreement according to aspects of the present disclosure.

FIG. 5 shows an example of a document template list according to aspects of the present disclosure.

FIG. 6 shows an example of an agreement signing interface according to aspects of the present disclosure.

FIG. 7 shows an example of a signing session summary according to aspects of the present disclosure.

FIG. 8 shows an example of a computing device for agreement signing according to aspects of the present disclosure.

### DETAILED DESCRIPTION

The following relates generally to document generation, and specifically to the generation of a signed document. Documents that require signatures (such as contracts, agreements, policies, etc.) may be generated using document generation software and shared with the signers of the document via digital communication channels (such as email, a website, cloud storage, etc.).

In some cases, a signer of a document may participate in a meeting relating to the document to be signed. For example, it is not uncommon in a meeting such as a video conference to find that a document needs to be signed by a participant of the meeting before any additional discussion can continue. For example, a non-disclosure agreement may need to be signed before discussing a new product launch, or an I-9 document may need to be filled and signed before an offer of employment can be extended.

In some cases, a document drafter may create a document in a document drafting application and may share a link to the created document in the meeting. However, conventional document generation techniques do not offer the ability to select information for generating a document to be signed in a user interface of the meeting. Without the ability to create a document within a meeting, a meeting host must change focus from a user interface of the meeting to other software, create the document, and then return to the user interface of the meeting to initiate an on-line signing process.

Accordingly, an aspect of the present disclosure provides a system for identifying an attendee of a live meeting, such as a video conference, an audio conference, a text-based conference, etc., as a signer of a document and preparing a data object for the attendee that includes the document and will accept the attendee's signature.

For example, the system provides a user interface that guides a host of the meeting through a process of selecting a document template that provides the contents of the data object and selecting the attendee as an intended signer of the document. The system confirms the identity of the attendee by examining credentials that the attendee provided to log in to the live meeting. The system then generates the data object to include the contents of the host-selected document template and a set of form fields that accept values including the name of the attendee and a corresponding signature.

After the system generates the data object, the user interface allows the host to begin a signing process, during which the host and the attendee can review and discuss the document in the user interface of the meeting and the system collects the attendee's signature. The system adds the signature as a value for a corresponding form field in the data object, and then generates a signed data object that includes the document and the signature. The system thereby provides information that establishes that the attendee has signed the document. The system can generate a representation of a signed document based on the signed data object that visually connects a representation of the attendee's signature with a representation of the contents of the document.

An example use of the present disclosure in a collaborative agreement signing context is generating a data object that includes a document and accepts a signature for the document during a video conference. For example, a host and an attendee are participating in a video conference initiated using the system, and the host determines that the attendee must sign a non-disclosure agreement (NDA) before discussion can continue. The system provides a user interface that allows the host to select an NDA template from a list of document templates and to identify the attendee as an intended signer for the NDA. The system assigns the attendee as a signer for the NDA based on retrieving the email address that the attendee used to log in to the video conference.

After the system confirms that the attendee is the intended signer of the document, the system generates a data object including the contents of the NDA and form fields that accept values equal to the name of the attendee and an electronic signature of the attendee. In response to an input from the host, the system initiates a signing process, during which the user interface of the meeting displays the contents of the NDA so that the host and the attendee can discuss the contents, and during which the data object accepts the attendee's signature for the NDA. The system generates a signed data object by populating the relevant form field with the received signature, thereby establishing that the attendee has signed the NDA and allowing the host and the attendee to proceed with the discussion. The system can use the signed data object to generate a representation of the signed NDA, including the text of the NDA, the name of the attendee, and a representation of the signature of the attendee.

According to some aspects, an agreement signing system including a communication component, a signing component, an integration component, and an agreement generation component is provided. In some cases, the communication component initiates a live communication session including a user. In some cases, the signing component displays an agreement signing interface for a document in a user interface of the live communication session and identifies the user as a signer of the document. In some cases, the integration component obtains a signature for the document from the user via the agreement signing interface. In some cases, the agreement generation component generates a signed document including the signature.

According to some aspects, the live communication session is a period of real-time or near real-time communication that is provided via a software application that is associated with a GUI. According to some aspects, the software application is the communication component. Accordingly, examples of a live communication session include a video conference, an audio conference, a text-based chat session, etc., that are associated with a GUI of a computing device.

By leveraging the user interface of the meeting to gather information about the agreement to be signed and the intended signer of the agreement, the system streamlines the creation of a signed agreement within a single live meeting, thereby avoiding a burdensome process of switching away from a user interface of a live meeting to another user interface of external software to generate an agreement for signing.

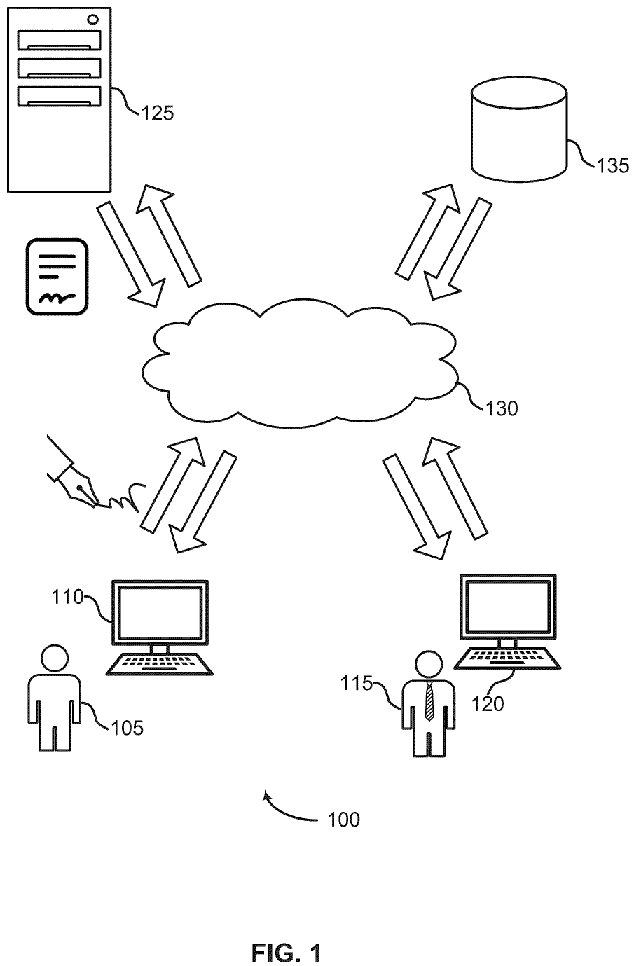

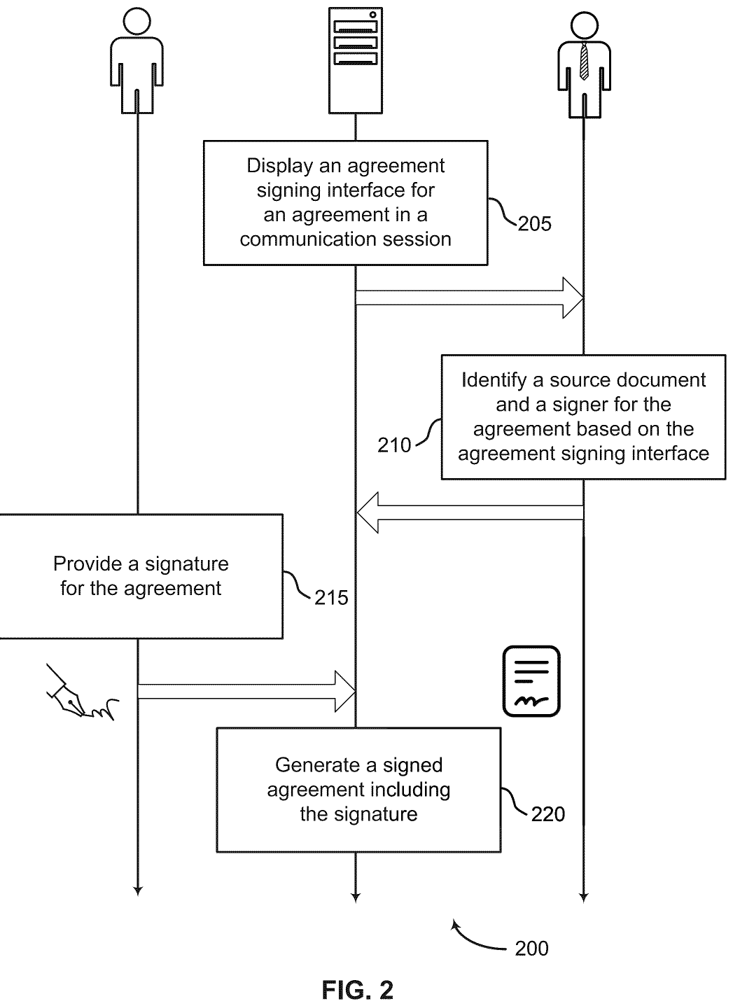

Further example applications of the present disclosure in the collaborative agreement signing context are provided with reference to FIGS. 1 and 2. Details regarding the architecture of the system are provided with reference to FIGS. 1, 3, and 8. Examples of a process for collaborative agreement signing are provided with reference to FIGS. 2 and 4-7.

### Document Signing System

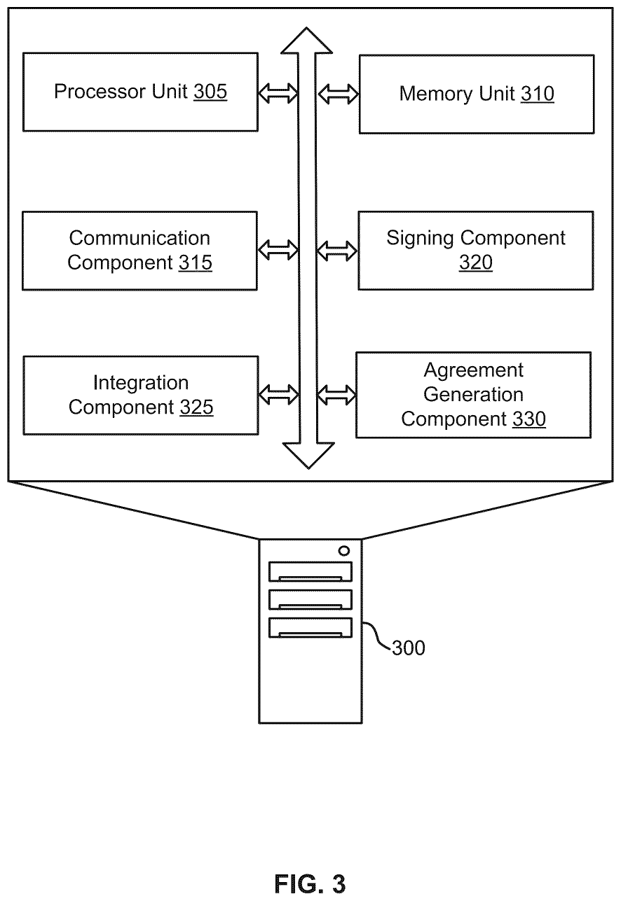

FIG. 1 shows an example of an agreement signing system 100 according to aspects of the present disclosure. The example shown includes first user 105, first user device 110, second user 115, second user device 120, agreement signing apparatus 125, cloud 130, and database 135. Agreement signing apparatus 125 is an example of, or includes aspects of, the corresponding element described with reference to FIG. 3.

Referring to FIG. 1, according to some aspects, agreement signing apparatus 125 initiates a live communication session including first user 105 and second user 115 and displays an agreement signing interface to second user 115 in a user interface of the live communication session.

As used herein, an “agreement” is a data structure that comprises a document (or template document), a set of fields, values corresponding to the fields, a list of signers, a set of signatures, or any combination thereof. In some examples, the agreement may be generated during a live communication session.

As used herein, a “live communication session” is period of real-time or near real-time communication. According to some aspects, the real-time or near real-time communication includes an exchange of data between one or more computing devices via communication components (including hardware, firmware, software, or a combination thereof) of the computing devices and according to a communication protocol. Examples of real-time or near real-time communication include the exchange of video, audio, and text data, or a combination thereof.

In some cases, second user 115 is a host of a signing session, during which a signed agreement is generated. According to some aspects, agreement signing apparatus 125 identifies an agreement to be signed and first user 105 as a signer of the agreement via inputs provided to the agreement signing interface by second user 115. According to some aspects, in response to the identification, agreement signing apparatus 125 initiates a signing session, generates the agreement to be signed, and prompts first user 105 to confirm their identity and to sign the agreement. According to some aspects, after receiving the signature from first user 105, agreement signing apparatus 125 generates a signed agreement including the agreement, a name of the signer of the agreement, and a signature of the signer of the agreement, and ends the signing session.

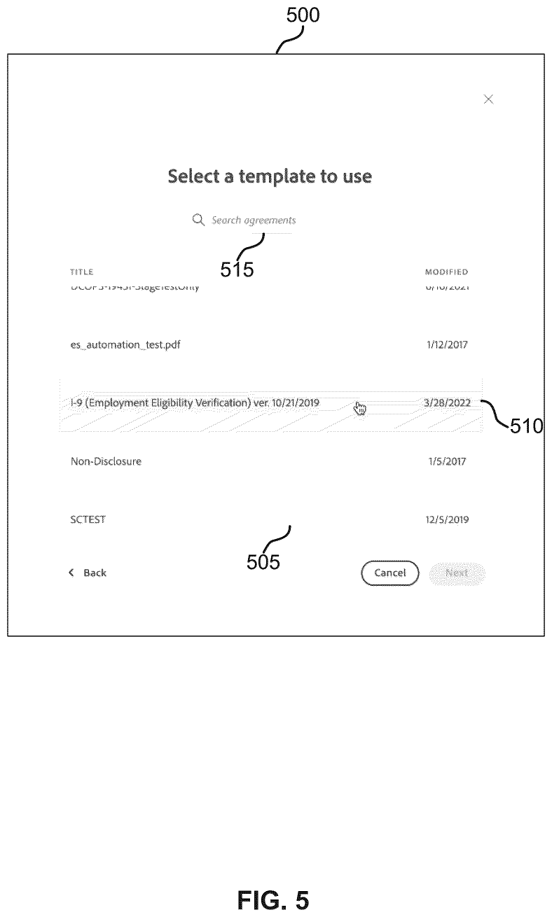

According to some aspects, each of first user device 110 and second user device 120 is a personal computer, laptop computer, mainframe computer, palmtop computer, personal assistant, mobile device, or any other suitable processing apparatus. In some examples, each of first user device 110 and second user device 120 includes software that respectively allows first user 105 and second user 115 to provide inputs to view a user interface of a live communication session and to provide inputs to the user interface as described with reference to FIG. 5.

According to some aspects, user interfaces enable first user 105 and second user 115 to respectively interact with first user device 110 and second user device 120. In some aspects, each of the user interfaces may include an audio device, such as an external speaker system, an external display device such as a display screen, or an input device (e.g., a remote control device interfaced with the user interface directly or through an I/O controller module). In some cases, the user interfaces may be a graphical user interface (GUI). According to some aspects, a user interface is included in agreement signing apparatus 125, and first user 105 and/or second user 115 interact directly with agreement signing apparatus 125 via the user interface. According to some aspects, the user interface is provided by agreement signing apparatus 125 via first user device 110 and second user device 120, and first user 105 and second user 115 interacts with agreement signing apparatus 125 via the user interface.

According to some aspects, agreement signing apparatus 125 includes a computer implemented network. In some aspects, agreement signing apparatus 125 also includes one or more processors, a memory subsystem, a communication interface, an I/O interface, one or more user interface components, and a bus. In some aspects, agreement signing apparatus 125 communicates with first user device 110, second user device 120, database 135, or a combination thereof via cloud 130.

In some cases, agreement signing apparatus 125 is implemented on a server. A server provides one or more functions to users linked by way of one or more of various networks, such as cloud 130. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP) and simple mail transfer protocol (SMTP), although other protocols such as file transfer protocol (FTP) and simple network management protocol (SNMP) may also be used. In some cases, the server is configured to send and receive hypertext markup language (HTML) formatted files (e.g., for displaying web pages). In various aspects, the server comprises a general purpose computing device, a personal computer, a laptop computer, a mainframe computer, a supercomputer, or any other suitable processing apparatus. Agreement signing apparatus 125 is an example of, or includes aspects of, the corresponding element described with reference to FIG. 2 and/or FIG. 3.

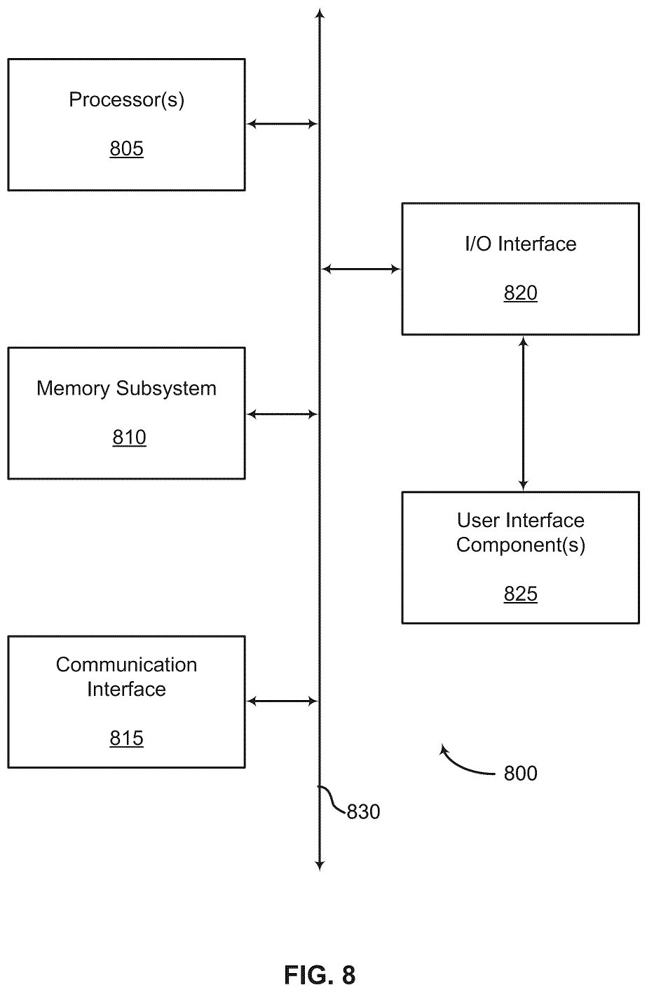

Further detail regarding the architecture of agreement signing apparatus 125 is provided with reference to FIGS. 3 and 8. Further detail regarding a process for collaborative agreement signing is provided with reference to FIGS. 2 and 4-7.

According to some aspects, cloud 130 is a computer network configured to provide on-demand availability of computer system resources, such as data storage and computing power. In some examples, cloud 130 provides resources without active management by first user 105 and/or second user 115. The term “cloud” is sometimes used to describe data centers available to many users over the Internet. Some large cloud networks have functions distributed over multiple locations from central servers. A server is designated an edge server if it has a direct or close connection to a user. In some cases, cloud 130 is limited to a single organization. In other examples, cloud 130 is available to many organizations. In one example, cloud 130 includes a multi-layer communications network comprising multiple edge routers and core routers. In another example, cloud 130 is based on a local collection of switches in a single physical location. According to some aspects, cloud 130 provides communications between first user device 110, second user device 120, agreement signing apparatus 125, database 135, or a combination thereof.

According to some aspects, database 135 is an organized collection of data. In some aspects, database 135 stores data in a specified format known as a schema. According to some aspects, database 135 is structured as a single database, a distributed database, multiple distributed databases, an emergency backup database, or a combination thereof. In some cases, a database controller manages data storage and processing in database 135. In some cases, first user 105 and/or second user 115 interact with the database controller. In other cases, the database controller operates automatically without user interaction. According to some aspects, database 135 stores a document template list, source documents corresponding to the document template list, a signing session summary, a user display name, a user identifier, a signing session context, a context token, an agreement, a signature input, a signature associated with the signature input, a signed agreement, or a combination thereof as described with reference to FIG. 5. In some aspects, database 135 is external to agreement signing apparatus 125 and communicates with agreement signing apparatus 125 via cloud 130. In some aspects, database 135 is included in agreement signing apparatus 125.

FIG. 2 shows an example of a method 200 for signing an agreement in a live communication session according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, the system initiates a live communication session and displays an agreement signing interface to a second user of the live communication session, such as a host of a signing session. In some cases, the agreement signing interface facilitates the identification of the agreement and an assignment of the first user signer of the agreement, and is used to initiate a signing session, during which the signed agreement is generated.

In some examples, an “agreement” is a data structure that include comprises a document (or template document), a set of fields, values corresponding to the fields, a list of signers, a set of signatures, or any combination thereof. In some examples, the agreement may be generated during a live communication session that is based on teleconferencing software. A document signing service may be integrated into the teleconferencing software, and may be used to generate the agreement and sign the agreement during a live communication session. For example, a signing process or ceremony initiated by the signing service may be conducted within the live communication session of the teleconferencing software. Once all of the signatures are collected for the list of signers, the agreement can be considered signed or closed. In some cases, the signed or closed agreement (i.e., the signed document) is generated during the live communication session by identifying a document, setting values for the fields (optionally), identifying or selecting the list of signers, and by obtaining signatures from the signers.

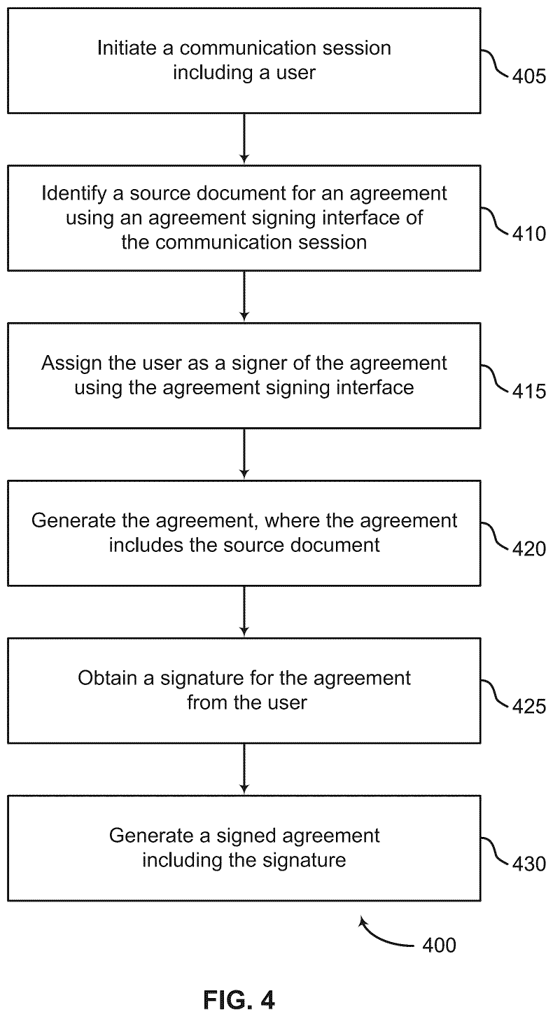

At operation 205, the system displays an agreement signing interface for an agreement in a live communication session. In some cases, the operations of this step refer to, or may be performed by, an agreement signing apparatus as described with reference to FIGS. 1 and 3. In some cases, the agreement signing apparatus displays the agreement signing interface for the agreement in the live communication session as described with reference to FIG. 4.

At operation 210, a second user identifies a source document and a signer for the agreement based on the agreement signing interface. In some cases, the operations of this step refer to, or may be performed by, a second user as described with reference to FIG. 1. In some cases, the second user (e.g., a host of a signing session) identifies a source document for the agreement and assigns the first user as a signer of the agreement based on the agreement signing interface as described with reference to FIG. 4.

At operation 215, a first user provides a signature for the agreement. In some cases, the operations of this step refer to, or may be performed by, a first user as described with reference to FIG. 1. In some cases, the first user provides a signature for the agreement as described with reference to FIG. 4.

At operation 220, the system generates a signed agreement including the signature. In some cases, the operations of this step refer to, or may be performed by, an agreement signing apparatus as described with reference to FIGS. 1 and 3. In some cases, the agreement signing apparatus generates the signed agreement including the signature based on the agreement as described with reference to FIG. 4.

FIG. 3 shows an example of an agreement signing apparatus according to aspects of the present disclosure. Agreement signing apparatus 300 is an example of, or includes aspects of, the corresponding element described with reference to FIG. 1.

In one aspect, agreement signing apparatus 300 includes processor unit 305, memory unit 310, communication component 315, signing component 320, integration component 325, and agreement generation component 330. According to some aspects, agreement signing apparatus is an example of, or includes aspects of, the computing device described with reference to FIG. 8. For example, in some cases, communication component 315, signing component 320, integration component 325, and agreement generation component 330 are implemented as hardware circuits that interact with components similar to the ones illustrated in FIG. 8 via a channel. For example, in some cases, communication component 315, signing component 320, integration component 325, and agreement generation component 330 are implemented as software stored in a memory device.

Processor unit 305 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, processor unit 305 is configured to operate a memory array using a memory controller. In other cases, a memory controller is integrated into processor unit 305. In some cases, processor unit 305 is configured to execute computer-readable instructions stored in memory unit 310 to perform various functions. In some aspects, processor unit 305 includes special purpose components for modem processing, baseband processing, digital signal processing, or transmission processing.

Memory unit 310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor of processor unit 305 to perform various functions described herein. In some cases, memory unit 310 includes a basic input/output system (BIOS) that controls basic hardware or software operations, such as an interaction with peripheral components or devices. In some cases, memory unit 310 includes a memory controller that operates memory cells of memory unit 310. For example, the memory controller may include a row decoder, column decoder, or both. In some cases, memory cells within memory unit 310 store information in the form of a logical state.

According to some aspects, communication component 315 initiates a live communication session including a user. According to some aspects, communication component 315 is implemented as software stored in memory unit 310 and executable by processor unit 305, as firmware, as one or more hardware circuits, or as a combination thereof.

According to some aspects, signing component 320 identifies a source document for an agreement using an agreement signing interface of the live communication session. In some examples, signing component 320 assigns the user as a signer of the agreement using the agreement signing interface.

In some examples, signing component 320 displays a document template list in the agreement signing interface of the live communication session, where the source document is identified based on the document template list. In some aspects, the document template list includes a representation of a source document. In some examples, signing component 320 selects the agreement for signing based on the representation of the source document.

In some examples, signing component 320 authenticates the user based on a user identifier. In some examples, signing component 320 includes the user identifier in a user identifier field of the agreement signing interface in response to the authentication. In some examples, signing component 320 determines that the user is not authenticated. In some examples, signing component 320 displays a request to provide a user identifier for the user in the agreement signing interface.

In some examples, signing component 320 displays a summary of a signing session within the agreement signing interface, where the summary includes a user identifier and a representation of the source document. In some examples, signing component 320 initiates a signing session, where the signature is obtained during the signing session. In some examples, signing component 320 displays an indication in the user interface of the live communication session that the signed agreement includes the signature.

According to some aspects, signing component 320 is implemented as software stored in memory unit 310 and executable by processor unit 305, as firmware, as one or more hardware circuits, or as a combination thereof.

According to some aspects, integration component 325 generates the agreement, where the agreement includes the source document. In some examples, integration component 325 obtains a signature for the agreement from the user. In some examples, integration component 325 generates a signing session context for the signing session, where the signed agreement is based on the signing session context.

According to some aspects, integration component 325 is implemented as software stored in memory unit 310 and executable by processor unit 305, as firmware, as one or more hardware circuits, or as a combination thereof.

According to some aspects, agreement generation component 330 generates a signed agreement including the signature. According to some aspects, agreement generation component 330 is implemented as software stored in memory unit 310 and executable by processor unit 305, as firmware, as one or more hardware circuits, or as a combination thereof.

According to some aspects, agreement signing apparatus 300 is implemented as a computing device, such as a computing device described with reference to FIG. 8, and communication component 315, signing component 320, integration component 325, agreement generation component 330, or a combination thereof are implemented as one or more software applications stored in memory unit 310 and executable by processor unit 305. For example, in some cases, communication component 315, signing component 320, integration component 325, agreement generation component 330, or a combination thereof are implemented as an agreement signing application stored in memory unit 310 and executable by processor unit 305.

According to some aspects, agreement signing apparatus 300 is implemented as one or more servers, such as a server described with reference to FIG. 1, and communication component 315, signing component 320, integration component 325, agreement generation component 330, or a combination thereof are implemented as one or more servers that are configured to communicate with each other, such as by a cloud as described with reference to FIG. 1, and by one or more communication protocols. In some cases, communication component 315, signing component 320, integration component 325, agreement generation component 330, or a combination thereof communicate with each other via API calls. According to some aspects, integration component 325 is implemented as an integration server. According to some aspects, the integration server is external to agreement signing apparatus 300.

### Collaborative Agreement Signing

A method for collaborative agreement signing is described with reference to FIGS. 4-7. One or more aspects of the method include initiating a live communication session including a user; identifying a source document for an agreement using an agreement signing interface of the live communication session; assigning the user as a signer of the agreement using the agreement signing interface; generating the agreement, wherein the agreement includes the source document; obtaining a signature for the agreement from the user; and generating a signed agreement including the signature.

Some examples of the method further include displaying a document template list in the agreement signing interface of the live communication session, where the source document is identified based on the document template list. In some aspects, the document template list comprises a representation of the source document. Some examples of the method further include selecting the agreement for signing based on the representation of the source document.

Some examples of the method further include authenticating the user based on a user identifier. Some examples further include including the user identifier in a user identifier field of the agreement signing interface in response to the authentication. Some examples of the method further include determining that the user is not authenticated. Some examples further include displaying a request to provide a user identifier for the user in the agreement signing interface.

Some examples of the method further include displaying a summary of a signing session within the agreement signing interface, wherein the summary includes a user identifier and a representation of the source document. Some examples of the method further include initiating a signing session, wherein the signature is obtained during the signing session. Some examples of the method further include generating a signing session context for the signing session, wherein the signed agreement is based on the signing session context. Some examples of the method further include displaying an indication in the user interface of the live communication session that the signed agreement includes the signature.

FIG. 4 shows an example of a method 400 for generating a signed agreement according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 4, according to some aspects, the system initiates a live communication session and uses prompts displayed via an agreement signing interface of a user interface of the live communication session to obtain information for and initiate a signing session. According to some aspects, during the signing session, a selected source document is prepared for signing as an agreement by a host of a signing session. For example, in some cases, the host of the signing session selects a source document for the agreement, and assigns a user of the live communication session as a signer of the agreement. As used herein, the term “source document” refers to any data that is organized as a computer file. Examples of a source document include a text file, a PDF, a word processing document, a video file, an audio file, or any other kind of file. As used herein, the term “agreement” refers to an object that is capable of including content (such as content included in the source document) and an electronic signature, either as data or as embedded metadata. In some cases, the agreement includes contents of the source document. In some cases, the agreement includes form fields and values for the form fields.

According to some aspects, the signing session ends when each user assigned as a signer of the agreement signs the agreement, and a signed agreement is generated. According to some aspects, by providing the agreement signing interface for obtaining the information for the agreement and initiating the signing session in the user interface of the live communication session, the system enables a user to easily prepare an agreement for signing without switching out of the user interface of the live communication session to a separate user interface of an agreement preparation application or the like.

At operation 405, the system initiates a live communication session including a user. In some cases, the operations of this step refer to, or may be performed by, a communication component as described with reference to FIG. 3. According to some aspects, a live communication session is period of real-time or near real-time communication. According to some aspects, the real-time or near real-time communication includes an exchange of data between one or more computing devices via communication components (including hardware, firmware, software, or a combination thereof) of the computing devices and according to a communication protocol. Examples of real-time or near real-time communication include the exchange of video, audio, and text data, or a combination thereof.

According to some aspects, the live communication session is a period of real-time or near real-time communication that is provided via a software application that is associated with a GUI. According to some aspects, the software application is the communication component. Accordingly, examples of a live communication session include a video conference, an audio conference, a text-based chat session, etc., that are associated with a GUI of a computing device.

According to some aspects, a live communication session includes a “host”. According to some aspects, the host is a user who prompts the communication component to initiate the live communication session, or is a user who is determined to be a host during the course of the live communication session. According to some aspects, a user included in the live communication session is identified according to a user identifier. According to some aspects, the user identifier is an identifier, such as an email address, that the user uses to log-in to software associated with the live communication session (e.g., the communication component).

According to some aspects, a user who is not logged in to the software associated with the live communication session is provided by the communication component with a temporary user identifier based on, for example, a characteristic of the user device associated with the user. According to some aspects, the communication component associates a host identifier with a user who is a host of the live communication session. According to some aspects, the communication component stores the user identifier, the host identifier, an association of the user identifier and/or the host identifier, or a combination thereof in a database as described with reference to FIG. 1.

At operation 410, the system identifies a source document for an agreement using an agreement signing interface of the live communication session. In some cases, the operations of this step refer to, or may be performed by, a signing component as described with reference to FIG. 3. For example, according to some aspects, the signing component receives an agreement signing initiation input and displays the agreement signing interface in response to the agreement signing initiation input.

According to some aspects, a user of the live communication session provides the agreement signing initiation input to a user interface of the live communication session (e.g., a GUI provided by a software application associated with the live communication session, such as the communication component), and the GUI provides the agreement signing initiation input to the user in response to the agreement signing initiation input. According to some aspects, the signing component displays the agreement signing interface in the user interface of the live communication session in response to receiving the agreement signing initiation input. As an example, in some cases, the agreement signing interface can be triggered from a user interface of the live communication session to initiate a process of displaying to the agreement signing interface to the host of the signing session. According to some aspects, the signing component identifies the user that provided the agreement signing initiation input as a host of a signing session.

According to some aspects, messages displayed in the agreement signing interface (for example, a dialog) guides the host of the signing session through a configuration of the signing session.

According to some aspects, the signing component displays a document template list in the agreement signing interface of the live communication session. According to some aspects, the document template list includes a representation of a source document. According to some aspects, the representation of the source document is a thumbnail image representation of the source document. According to some aspects, the signing component fetches the document template list (for example, from the database described with reference to FIG. 1) using the user identifier or other credentials of the host of the signing session.

According to some aspects, the signing component selects the agreement for signing based on the representation of the source document. For example, the host of the signing session may choose a source document for the agreement by providing a selection input to the agreement signing interface to select the representation of the source document from the document template list, and the signing component selects an agreement corresponding to the selected source document. According to some aspects, the document template list, the source documents associated with the document template list, and representations of the source documents are stored in a database as described with reference to FIG. 1. An example of an agreement signing interface including a document template list is illustrated in FIG. 5.

At operation 415, the system assigns the user as a signer of the agreement using the agreement signing interface. In some cases, the operations of this step refer to, or may be performed by, a signing component as described with reference to FIG. 3. For example, according to some aspects, in response to selecting the representation of the source document, the signing component provides a request in the agreement signing interface to the host of the signing session that a user be assigned as a signer of the agreement. According to some aspects, the signing component displays a user name associated with a user of the live communication session in the agreement signing interface, the host of the signing session can select the user to be a signer of the agreement, and the signing component assigns the user as a signer of the agreement in response to the selection.

According to some aspects, the signing component authenticates the user based on a user identifier and includes the user identifier in a user identifier field of the agreement signing interface in response to the authentication. According to some aspects, the signing component determines that the user is not authenticated and displays a request to provide a user identifier for the user in the agreement signing interface.

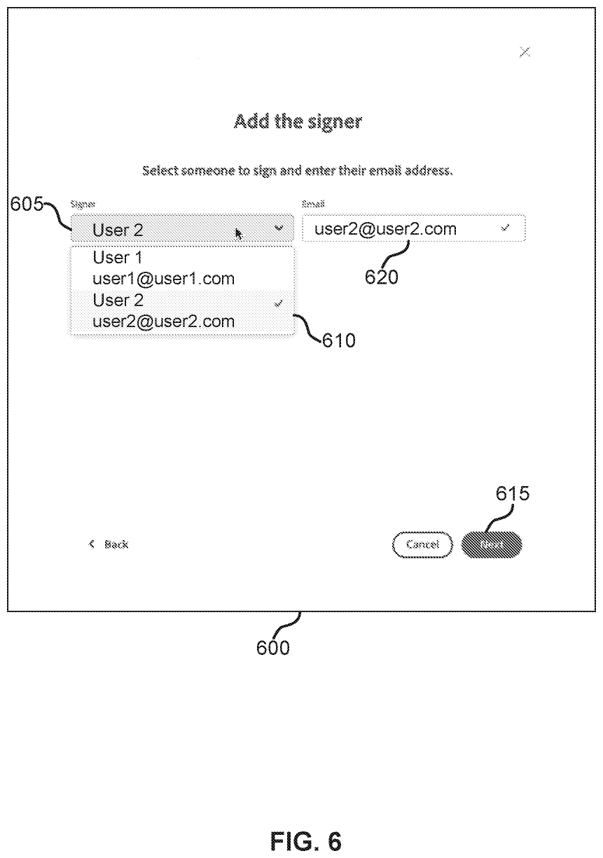

For example, according to some aspects, if the user has been authenticated into the live communication session by the communication component via a log-in with a user identifier such as an email address and the like, then the signing component authenticates the user and automatically populates a user identifier field of the agreement signing interface with the user identifier of the user. According to some aspects, if the user has not been authenticated into the live communication session by the communication component, the signing component prompts the host via the agreement signing interface to enter a valid user identifier for the user. An example of an agreement signing interface including a user name and a user identifier is illustrated in FIG. 6.

According to some aspects, a message displayed in the agreement signing interface (such as a dialog) includes a request to choose the user to sign the agreement. For example, in some cases, the message includes a dropdown control including a list of the users of the live communication session. In some cases, the signing component fetches the list of the users using an API associated with the live communication session and returns a user display name, a unique identifier for the user, and, if the user is authenticated into the live communication session, the user identifier for the user (such as an email address). According to some aspects, when the host of the signing session selects a user, if there is a user identifier for the user available to the signing component, the signing component automatically fills the user identifier field of the message. According to some aspects, if the user is not authenticated in the live communication session, the host of the signing session can manually enter the user identifier of the user into the message.

At operation 420, the system generates the agreement, where the agreement includes the source document. In some cases, the operations of this step refer to, or may be performed by, an integration component as described with reference to FIG. 3.

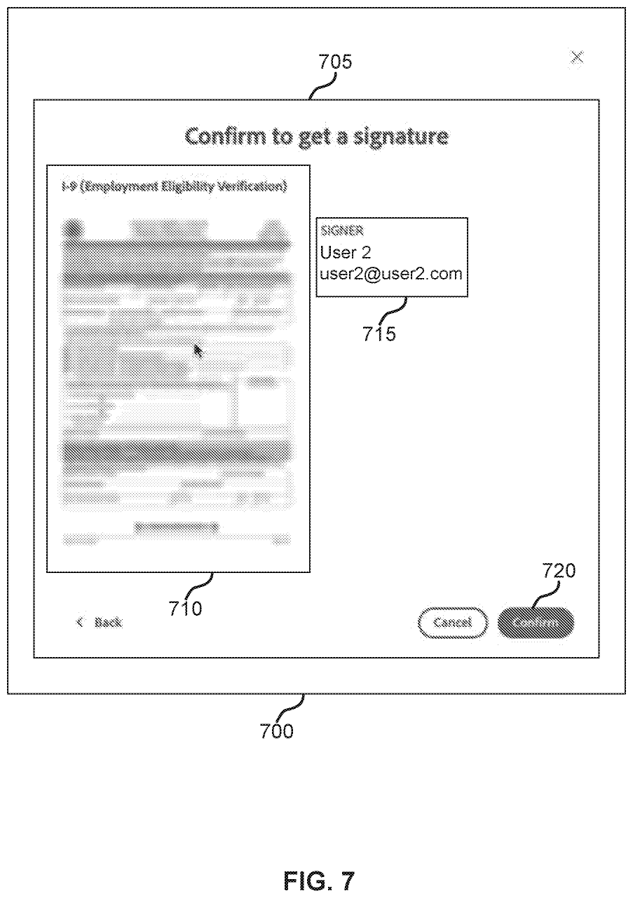

According to some aspects, the signing component displays a summary of a signing session within the agreement signing interface, wherein the summary includes a user identifier and the representation of the source document. According to some aspects, a signing session (e.g., a signing ceremony) is a series of processes related to generating a signed agreement. According to some aspects, the signing component displays the representation of the source document, a name of the source document, the user's display name, and the user identifier in the agreement signing interface as the summary. An example of agreement signing interface including a summary of a signing session including a user name, a user identifier, and a representation of a source document is illustrated in FIG. 7.

According to some aspects, the signing component initiates the signing session, where the agreement is generated in response to initiating the signing session. For example, according to some aspects, the host of the signing session provides a confirmation input to a portion of the agreement signing interface, and the signing component initiates the signing session in response to the confirmation input. For example, in some aspects, the host of the signing session clicks on a confirmation button to accept a configuration of the signing session, and the signing component initiates the signing session using data associated with the signing session summary (such as the document corresponding to the representation of the source document, the name of the document, the user name, and/or the user identifier).

According to some aspects, the signing component sends the data associated with the signing session summary to the integration component, thereby initiating the signing session. An example of an agreement signing interface including a confirmation button is illustrated in FIG. 7.

According to some aspects, the signing component closes the agreement signing interface in response to the confirmation input and sends a message (for example, via a chat interface of the user interface of the live communication session) to the integration component. According to some aspects, the message includes the data associated with the signing session summary, and the integration component uses the data associated with the signing session summary to set the user as a signer of the agreement based on the user identifier. According to some aspects, the message instructs the integration component to generate the agreement including the source document and one or more form fields corresponding to the information included in the signing session summary.

For example, in some cases, the integration component extracts the data associated with the signing session summary from the message, and using the source document and user identifier of the user chosen to sign the document, the integration component generates the agreement such that the agreement includes the content of the source document. In some cases, the agreement includes a form field corresponding to a name of the user associated with the user identifier. In some cases, the agreement includes a form field corresponding to the user identifier. In some cases, the agreement includes a form field corresponding to a signature of the user.

According to some aspects, the integration component generates a signing session context for the signing session, where the signed agreement is based on the signing session context. According to some aspects, the signing session context includes state data for orchestrating the signing session. According to some aspects, the integration component provides the signing session context to the database as described with reference to FIG. 1.

According to some aspects, the state data includes a context token based on index values retrieved from the database. In some cases, the context token is salted and encrypted so that it may be passed as an opaque token (for example, via various API calls associated with the signing session). Encryption is the process of translating data into something that appears to be random. Decryption is the process of converting the encrypted data back into its original form. Symmetric encryption may be used to encrypt large amounts of data. For example, a symmetric key may be used during both the encryption and decryption processes. In some examples, an encryption algorithm may be used to make it as difficult as possible to decrypt the data without using the key. In some cases, there may be no technique significantly better than trying every possible key. For such an algorithm, using a longer key makes it more difficult to decrypt the data without the key. Examples of encryption algorithms include a data encryption standard (DES), triple DES, advanced encryption standard (AES), Rivest Shamir Adleman (RSA), or elliptic curve cryptosystem (ECC).

In some cases, in each step of the signing session, the opaque context token is passed through the APIs to synchronize the signing session with the state of the document. In some cases, the integration component registers a callback with the signing component for events related to changes of state of the document being signed, thereby adding the context token as part of callback data. In some cases, the context token is decrypted to obtain data from the context token and re-encrypted in each step of the signing session.

At operation 425, the system obtains a signature for the agreement from the user. In some cases, the operations of this step refer to, or may be performed by, an integration component as described with reference to FIG. 3.

According to some aspects, during the signing session, the integration component provides a message (such as a card in a chat interface) via the user interface of the live communication session that invites the identified user to provide a review input to the user interface to review and sign the agreement. In some cases, the integration component provides the message via one or more APIs.

In some cases, a portion of the user interface (such as a “command” button) includes a command identifier indicating that the portion of the user interface is used to provide the review input. In some cases, the context token is included in the message to associate an input to the portion of the user interface (such as a click of the command button) and the command identifier with the signing session. In some cases, each user of the live communication session can see the invitation to sign, but only the identified user can cause the signing session to proceed by providing the review input.

According to some aspects, in response to receiving the review input, the integration component displays to the identified via the user interface of the live communication session a message (such as a dialog) prompting the identified user to confirm their identity by providing an accept input to the user interface. In some cases, in response to another user of the live communication session attempting to provide an accept input to the user interface, the integration component displays a message indicating that the other user is not the user identified as the signer.

For example, when a user provides the accept input, the integration component checks the identity of the user by comparing the user identifier with data extracted from the signing session context (e.g., fetched using the context token). In some cases, if the user matches the user identifier of the user identified as the signer, then the integration component displays a request to the user to provide an identity affirmation input to the user interface of the live communication session. In some cases, if the user identifier does not match the user identified as the signer of the document, then the integration component displays a message to the user informing the user that they are not the chosen signer.

According to some aspects, after the integration component receives the identity affirmation input via the user interface of the live communication session, the integration component instructs the signing component to display the source document to the identified user.

According to some aspects, the signing component displays the source document in the user interface of the live communication session. According to some aspects, the signing component displays the source document to the identified user in a web browser (such as a web browser implemented on a user device associated with the identified user). For example, in some cases, after the integration component receives the identity affirmation input via the user interface of the live communication session, the integration component provides a web link to the identified user, where the web link is a link to a signing page that displays the document corresponding to a URL. In some cases, the URL includes the context token for the signing session, where the context token includes a new salt value and indicates a signature step for which the context token is to be used.

According to some aspects, the user provides a link input to the web link, and the integration component receives a request for the signing page in response to the link input. In some cases, when the integration component receives the request for the signing page, the integration component fetches the signing session context using the context token and evaluates the state of the context token with respect to the signing session context. In some cases, if the state of the context token differs from the state of the signing session, the integration component returns an error page to the web browser. In some cases, if the signing session context and the context token include compatible states, the integration component uses data from the signing session context to fetch a signing access token and the URL, and the URL is returned as a redirect response to the web browser to take the user to the signing page to review and sign the agreement.

According to some aspects, in response to the signing page opening in the web browser, the signing component prompts the user to share the web browser in the user interface of the live communication session so that the source document can be discussed.

At operation 430, the system generates a signed agreement including the signature. In some cases, the operations of this step refer to, or may be performed by, an agreement generation component as described with reference to FIG. 3.

According to some aspects, the integration component receives a signature input from the identified user for the document in response to the identified user providing a signature input in the user interface of the live communication session or in the web browser.

According to some aspects, the integration component receives a callback message in response to the signature input indicating that a user has completed a step in the signing session, and the integration component extracts the context token from the callback message, fetches the signing session context from the database, and fetches a current state of the agreement. If the state of the agreement matches the callback message, and the state of the signing session context conforms to the expected previous step of the signing session, then the signing session context is updated to a new state (such as a state indicating that the signing session is complete) and the integration component posts a corresponding message to the user interface of the live communication session.

According to some aspects, the integration component updates the state of the context token in response to receiving the signature input. In some cases, the agreement generation component generates a signed agreement including a signature associated with the signature input based on the signing session data received from the integration component and/or the state of the context token. For example, in some cases, the signed agreement includes the agreement, a value equal to the name of the user in the form field corresponding to the name of the user, a value equal to the user identifier in the form field corresponding to the user identifier, a value equal to the signature in the form field corresponding to the signature of the user, or a combination thereof.

According to some aspects, the integration component checks that the context token and the signing session context indicate that all users who are identified as a signer have signed the agreement. When each of the identified users have signed the agreement, the integration component posts a corresponding message to the user interface of the live communication session and ends the signing session.

According to some aspects, in response to the end of the signing session, the signing component displays a representation of the agreement in the user interface of the live communication session. In some cases, the representation of the agreement includes the contents of the source document and a representation of any values included in the signed document. For example, in some cases, the representation of the agreement includes a text representation of the user name, the user identifier, the signature, or a combination thereof.

FIG. 5 shows an example of a document template list according to aspects of the present disclosure. Referring to FIG. 5, in some cases, agreement signing interface 500 is included in a user interface of a live communication session as described with reference to FIG. 4 and includes document template list 505.

FIG. 6 shows an example of an agreement signing interface according to aspects of the present disclosure. Referring to FIG. 6, in some cases, agreement signing interface 600 includes a menu including a user display name and a user identifier as described with reference to FIG. 4.

FIG. 7 shows an example of a signing session summary according to aspects of the present disclosure. Referring to FIG. 7, agreement signing interface 700 includes signing session summary 705 (including a representation of a source document, a source document name, a user display name, and a user identifier) and “confirm” button 710 through which a user can provide a confirmation input as described with reference to FIG. 4.

FIG. 8 shows an example of a computing device 800 for agreement signing according to aspects of the present disclosure. In one aspect, computing device 800 includes processor(s) 805, memory subsystem 810, communication interface 815, I/O interface 820, user interface component(s) 825, and channel 830.

In some aspects, computing device 800 is an example of, or includes aspects of, agreement signing apparatus 125 of FIG. 1. In some aspects, computing device 800 includes one or more processors 805 that can execute instructions stored in memory subsystem 810 to initiate a live communication session including a user; identifying a source document for an agreement using an agreement signing interface of the live communication session; assigning the user as a signer of the agreement using the agreement signing interface; generating the agreement, wherein the agreement includes the source document (either directly, or by reference); obtaining a signature for the agreement from the user; and generating a signed agreement including the signature.

According to some aspects, computing device 800 includes one or more processors 805. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some aspects, a processor includes special purpose components for modem processing, baseband processing, digital signal processing, or transmission processing.

According to some aspects, memory subsystem 810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 815 operates at a boundary between communicating entities (such as computing device 800, one or more user devices, a cloud, and one or more databases) and channel 830 and can record and process communications. In some cases, communication interface 815 is provided to enable a processing system coupled to a transceiver (e.g., a transmitter and/or a receiver). In some examples, the transceiver is configured to transmit (or send) and receive signals for a communications device via an antenna.

According to some aspects, I/O interface 820 is controlled by an I/O controller to manage input and output signals for computing device 800. In some cases, I/O interface 820 manages peripherals not integrated into computing device 800. In some cases, I/O interface 820 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 820 or via hardware components controlled by the I/O controller.

According to some aspects, user interface component(s) 825 enable a user to interact with computing device 800. In some cases, user interface component(s) 825 include an audio device, such as an external speaker system, an external display device such as a display screen, an input device (e.g., a remote control device interfaced with a user interface directly or through the I/O controller), or a combination thereof. In some cases, user interface component(s) 825 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

1. A method for collaborative document signing, comprising:
initiating a live communication session including a user, wherein the live communication session comprises a video or an audio telecommunication session;
identifying a source document for an agreement using an agreement signing interface of the live communication session;
initiating a signing session within the live communication session;
encrypting a context token corresponding to a signing session context for the signing session;
decrypting the context token to obtain a state of the context token;
creating the agreement during the signing session, wherein the agreement includes the source document and a list of signers;
assigning the user as a signer of the agreement using the agreement signing interface;
determining that the user has provided a signature for the agreement based on evaluating the state of the context token with respect to the signing session context; and
closing the signing session in response to the determination.

2. The method of claim 1, further comprising:
displaying a document template list in the agreement signing interface of the live communication session, wherein the source document is identified based on the document template list.

3. The method of claim 2, wherein:
the document template list comprises a representation of the source document.

4. The method of claim 3, further comprising:
selecting the agreement for signing based on the representation of the source document.

5. The method of claim 1, further comprising:
authenticating the user based on a user identifier; and
including the user identifier in a user identifier field of the agreement signing interface in response to the authentication.

6. The method of claim 1, further comprising:
determining that the user is not authenticated; and
displaying a request to provide a user identifier for the user in the agreement signing interface.

7. The method of claim 1, further comprising:
displaying a summary of the signing session within the agreement signing interface, wherein the summary includes a user identifier and a representation of the source document.

8. (canceled)

9. The method of claim 1, further comprising:
generating the signing session context for the signing session, wherein the signed agreement is based on the signing session context.

10. The method of claim 1, further comprising:
displaying an indication in the user interface of the live communication session that the signed agreement includes the signature.

11. A system comprising:
one or more processors; and
one or more memory components coupled with the one or more processors, the one or more processors configured to:
initiate a live communication session including a user, wherein the live communication session comprises a video or an audio telecommunication session;
identify a source document for an agreement using an agreement signing interface of the live communication session;
initiate a signing session within the live communication session;
encrypt a context token corresponding to a signing session context for the signing session;
decrypt the context token to obtain a state of the context token;
create the agreement during the signing session, wherein the agreement includes the source document and a list of signers;
assign the user as a signer of the agreement using the agreement signing interface;
determine that the user has provided a signature for the agreement based on evaluating the state of the context token with respect to the signing session context; and
close the signing session in response to the determination.

12. The system of claim 11, the one or more processors being further configured to:
display a document template list in the agreement signing interface of the live communication session, wherein the source document is identified based on the document template list.

13. The system of claim 11, the one or more processors being further configured to:
authenticate the user based on a user identifier; and
include the user identifier in a user identifier field of the agreement signing interface in response to the authentication.

14. The system of claim 11, the one or more processors being further configured to:
determine that the user is not authenticated; and
display a request to provide a user identifier for the user in the agreement signing interface.

15. The system of claim 11, the one or more processors being further configured to:
display a summary of the signing session within the agreement signing interface, wherein the summary includes a user identifier and a representation of the source document.

16. A non-transitory computer-readable medium storing instructions that, when executed by a processor, cause the processor to:
initiate a live communication session including a user, wherein the live communication session comprises a video or an audio telecommunication session;
identify a source document for an agreement using an agreement signing interface of the live communication session;
initiate a signing session within the live communication session;
encrypt a context token corresponding to a signing session context for the signing session;
decrypt the context token to obtain a state of the context token;
create the agreement during the signing session, wherein the agreement includes the source document and a list of signers;
assign the user as a signer of the agreement using the agreement signing interface;
determine that the user has provided a signature for the agreement based on evaluating the state of the context token with respect to the signing session context; and
close the signing session in response to the determination.

17. The non-transitory computer-readable medium of claim 16, wherein the instructions further cause the processor to:
display a document template list in the agreement signing interface of the live communication session, wherein the source document is identified based on the document template list.

18. The non-transitory computer-readable medium of claim 17, wherein:
the document template list comprises a representation of a source document.

19. The non-transitory computer-readable medium of claim 18, wherein the instructions further cause the processor to:
select the agreement for signing based on the representation of the source document.

20. The non-transitory computer-readable medium of claim 16, wherein the instructions further cause the processor to:
display a summary of the signing session within the agreement signing interface, wherein the summary includes a user identifier and a representation of the source document.
